(19) United States
(12) Patent Application Publication
(10) Pub. No.: US 2002/0189538 A1
(43) Pub. Date: Dec. 19, 2002

(54) Coated paperboard, method and apparatus for producing same

(76) Inventors: Dean P. Swoboda, DePere, WI (US); Michael A. Schmelzer, Appleton, WI (US)

Correspondence Address: Ferrell & Ferrell, L.L.P., Suite 401, 90 Crystal Run Road, Middletown, NY, 10941, US

(21) Appl. No.: 10/156,342

(22) Filed: May 28, 2002

Related U.S. Application Data
(60) Provisional application No. 60/294,793, filed on May 31, 2001.

(51) Int. Cl. B05C 1/00

(52) U.S. Cl. 118/230; 118/235

(57) ABSTRACT

A method and apparatus for coating a paperboard substrate includes an applicator for providing a metered amount of an aqueous polymeric coating to the paperboard substrate as well as dual smoothing bars to promote even distribution of the coating on the paperboard. The product exhibits enhanced barrier properties and printability at low coatweight amounts.

### CROSS-REFERENCE TO RELATED APPLICATION

This application is based upon United States Provisional Application No. 60/294,793 of the same title, filed May 31, 2001, the priority of which is hereby claimed.

### TECHNICAL FIELD

The present invention relates generally to methods of coating paperboard, and particularly to a coated paperboard produced by applying an aqueous polymeric coating to a substrate and smoothing the coating with dual smoothing bars. The coated paperboard exhibits enhanced barrier properties and printability and is particularly suitable for making disposable food containers by way of heat pressing in a matched die set.

### BACKGROUND

Various methods of applying aqueous polymer coatings and smoothing them are known in the art. There is disclosed in U.S. Pat. No. 2,911,320 to Phillips a method of coating a moving substrate comprising applying a coating in a nip and then smoothing the coating with a wet roller. There is disclosed in U.S. Pat. No. 4,078,924 to Keddie et al. a method and device for improving xerographic development of non-metallic photoreceptor imaging surfaces containing irregularities of 5 microns or larger by contacting and moving and abrading means against the irregular surface in the presence of an interposed hydrodynamic hydrostatic fluid bearing. There is disclosed in U.S. Pat. No. 4,238,533 to Pujol et al. a coating method including a coating roller and a rotating smooth rod arranged such that the path of travel of the film during the coating procedure is substantially a circular path whose diameter is around 1 meter. During the coating procedure the tension of the film is adjusted by way of the first and second guide rollers regulated independently of the speed at which the film travels. There is disclosed in U.S. Pat. No. 4,503,096 to Specht a method and device for the continuous application of a coating including a rotating application roller and a rotating smoothing roller located directly behind the application roller. U.S. Pat. No. 4,898,752 to Cavagna et al. teaches the coating of unbleached paper and paperboard while printing on a printing press. The unbleached raw stock must be relatively smooth and non-porous prior to coating and printing with a Sheffield roughness less than about 300 units for liner board and less than about 330 units for folding carton material. U.S. Pat. No. 5,033,373 to Brendel et al. teaches a process for producing a smooth and glossy surface on a paper web including a calendar arrangement for carrying out the process. The calendar arrangement includes two sets of rolls through which the paper web is conducted in succession. Each set of rolls includes a heated hard roll and a soft roll. U.S. Pat. No. 5,049,420 to Simons shows a coating including microcapsules applied to a paper web by passing the web through an ingoing nip between a hard applicator roll and a soft backing roll. Metering is achieved by means of a deformable metering roll in adjustable pressure contact with an applicator roll rotating in an opposite direction thereto to define the ingoing nip. U.S. Pat. No. 5,340,611 to Kustermann et al. discloses a process or coating of a running web of paper wherein a press gap formed between two rolls is used to apply a coating in relatively low coatweights. U.S. Pat. No. 5,609,686 to Jerry et al. discloses an apparatus for continuously smoothing a wet coating of magnetizable particles and binder on a moving flexible web.

Perhaps more pertinent to the description which follows are U.S. Pat. No. 4,521,459 to Takeda and U.S. Pat. No. 4,948,635 to Iwasaki. The '459 patent discloses a coating method wherein a coating section is arranged immediately before a wound rod coil bar which has a smoother bar disposed immediately after the coil bar. A coating solution is applied to a web which is run continuously with a surplus of coating which is scraped off the web by the coil bar and thereafter smoothed by a smoother bar. The '635 patent to Iwasaki discloses a Gravure coating device as well as a method for applying a coating to one side of a traveling continuous web. A pair of spaced rollers support the web on the uncoated side while a Gravure roller located between the rollers tangentially contacts the first side of the web. A doctor blade is utilized to remove excess coating from the Gravure roller. The disclosure of the foregoing patents is incorporated into this application by reference thereto.

### SUMMARY OF INVENTION

The present invention is directed, in part, to a process used for creating a smooth polymer coating with superior barrier properties, for example a styrene-butadiene resin over a non-clay coated paperboard surface with the least amount of coating possible. It is known in the art to produce paperboard for making paper plates that offer a reasonable amount of barrier properties formed from a trailing blade, clay-coated paperboard substrate. This smooth (1-2 microns, Parker Print test method), clay-coated paperboard substrate generally prints exceptionally well and can be easily topcoated with a minimal amount of expensive ($2-$4 per dry pound) functional coating applied after printing with a coating system designed to apply uniform low coatweights. An example of such a post printing coating system would be a hydrophilic coater.

If finished plate barrier properties are desired, the challenge with using non-clay coated paperboard is applying an economically reasonable amount of a coating at the printing press to fill in the rough paperboard surface. A rough paperboard surface can be visualized as a terrain having hills and valleys full of cracks and crevices, created by cellulose fibers that have arranged themselves in a somewhat random pattern. The hills can be leveled somewhat by calendaring, but calendaring is often limited by substrate caliper requirements.

To apply a sufficient amount of coating to form a continuous film capable of achieving barrier properties, a Gravure process may be utilized. Although Gravure technology can usually apply generous amounts of coating, it does not apply the coating evenly and smoothly in comparison to a trailing blade coater or a hydrophilic coater. Heavy coating weights applied with Gravure technology create puddles and pools of material often described in appearance as mottled, orange peel, or worm-tracked. Porous areas on the board absorb coating and do not film over. This creates a board surface with areas of high and low coating density. Areas of low coating density will not provide the required amount of barrier properties; whereas, both high and low density coating areas will negatively impact print quality.

It has been found in accordance with the present invention that utilizing a first and second smoothing bar greatly improves the distribution of a polymer coating, particularly water borne polymer coatings at relatively low coatweights as described hereinafter.

There is thus provided in a first aspect of the present invention an apparatus for applying an aqueous polymeric coating such as a water-borne latex emulsion to a paperboard substrate including:

(a) means for conveying a paperboard substrate having a basis weight of from about 75 to about 300 pounds per 3000 square foot ream in a production direction;

(b) applicator means for applying a metered amount of an aqueous polymeric coating to the paperboard substrate as it travels along the production direction;

(c) means for smoothing the aqueous coating on the paperboard substrate including:

(i) a first smoothing bar extending transversely to the production direction and being configured, dimensioned and positioned to contact the aqueous polymer coating and promote uniform distribution thereof over the surface of the paperboard substrate; and

(ii) a second smoothing bar proximately located with respect to the first smoothing bar likewise extending transversely to the production direction and likewise being configured dimensioned and positioned to contact the aqueous coating and promote uniform distribution thereof over the surface of the paperboard substrate.

In general, a Gravure or a coil coating rod can be used to meter, that is, to supply a predetermined amount of coating to the paperboard and it will be appreciated that it is important that the polymer coating is still wet when contacting the second smoothing bar. Thus, both smoothing bars are in proximity to one another.

In another aspect of the present invention there is provided a method of coating a paperboard substrate including the steps of:

(a) conveying the paperboard substrate having a basis weight of from about 75 pounds to about 300 pounds per 3000 square foot ream in the production direction;

(b) applying a metered amount of an aqueous polymer coating to the paperboard substrate as it travels along the production direction;

(c) smoothing the aqueous coating on the paperboard substrate by way of contacting the aqueous polymer coating with first and second smoothing bars disposed in proximity to one another and extending transversely across the traveling web. The smoothing bars are operative to promote uniform distribution of the aqueous polymeric coating on the paperboard substrate which is subsequently dried to form a polymer coated paperboard.

In yet another aspect of the present invention there is provided a coated paperboard substrate having a basis weight of from about 75 to about 300 pounds per 3000 square foot ream consisting essentially of a starch-sized cellulosic web provided with a base coating, wherein the base coating is applied to the paperboard substrate by applicator means and smoothed by first and second smoothing bars as noted above. The coated paperboard exhibits a Dye Stain Failure of less than about 10%. The smoothing bars, in general, do not meter or control the amount of coating applied to the paperboard substrate, but typically simply redistribute the material applied by the applicator.

In still yet another aspect of the present invention there is provided an unfilled coated paperboard having a basis weight of from about 75 to about 300 pounds per 3000 square foot ream consisting essentially of a starch-sized cellulosic web provided with a base coating consisting essentially of a resin coating in a coatweight amount of at least about 2 pounds per 3000 square foot ream, wherein the coated paperboard exhibits a Dye Stain Failure of less than about 10% and, under a given set of conditions, a Cyan Density of at least about 1.25. In this aspect of the invention, the base coating is substantially free of mineral filler, that is to say less than about 2 pounds of filler per 3000 square foot ream of paperboard and may thought of as unfilled or as “non-clay” coated paperboard.

A particularly preferred aspect of the present invention is directed to a coated paperboard having a basis weight of from about 75 pounds per 3000 square foot ream to about 300 pounds per 3000 square foot ream consisting essentially of a starch-sized cellulosic web provided with a base coating in an amount of from about 2 pounds per 3000 square foot ream to less than 4 pounds per 3000 square foot ream wherein the base coating is substantially free of pinholes having a dimension of 50 microns or greater. A base coating having such characteristics applied in an amount of less than about 3 pounds per 3000 square foot ream is even more preferred.

These and other aspects of the present invention will become apparent from the discussion which follows.

### BRIEF DESCRIPTION OF DRAWINGS

The invention is described in detail below with reference to the drawings wherein like numerals designate similar parts and wherein:

FIG. 1 is a schematic diagram of a first apparatus useful in practicing the present invention;

FIG. 2 is a schematic diagram of a second apparatus useful in practicing the process of the present invention;

FIG. 3 is an enlarged detail showing the smoothing bars of the present invention;

FIG. 4 is a representation of the results of a dye stain test on coated paperboard provided with a 2.1 lb/3,000 square foot ream styrene-butadiene coating by way of a Gravure coater without smoothing bars;

FIG. 5 is a representation of the results of a dye stain test on a coated paperboard provided with a 2.1 lb/3,000 square foot ream styrene-butadiene coating by way of a Gravure coater with 2 smoothing bars in accordance with the present invention; and

FIGS. 6-8 are photomicrographs (50×) of paperboard coated with 2.3 lbs/3000 square foot ream of a styrene-butadiene resin utilizing no smoothing bars, 1 smoothing bar and 2 smoothing bars, respectively.

### DETAILED DESCRIPTION

The invention is described in detail below with reference to the drawings and numerous examples. Such description is for exemplification only and is not limitative of the invention which is defined in the appended claims.

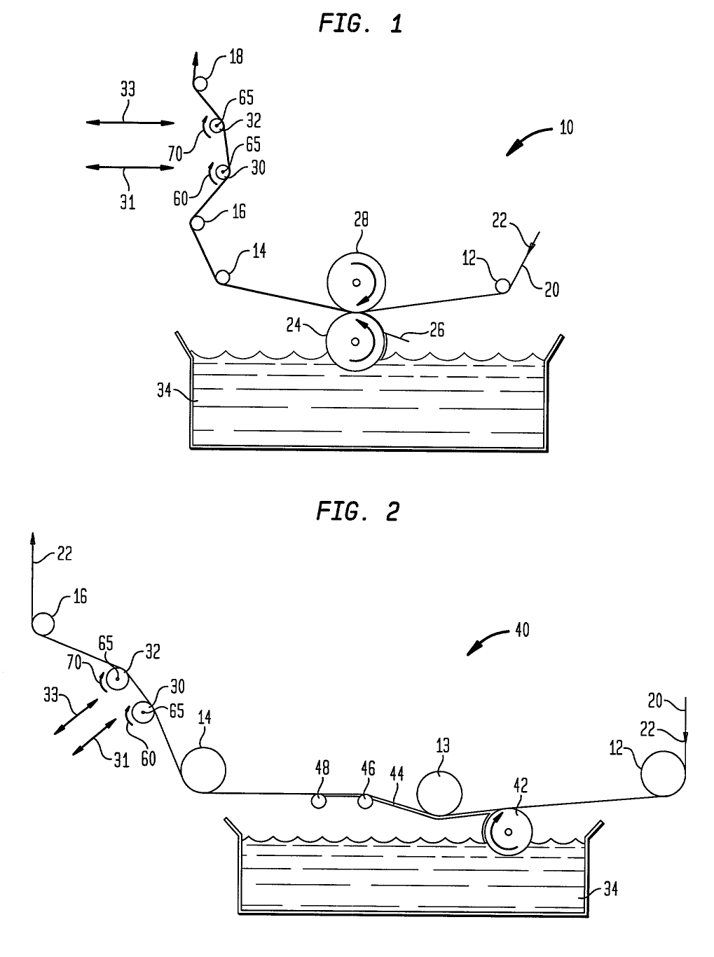

Referring to FIG. 1 there is shown a first apparatus 10, which may be used to apply coatings to paperboard substrates in accordance with the present invention. Apparatus 10 includes a plurality of guide rolls 12, 14, 16, and 18 as shown which may be used to assist conveying the paperboard web 20 in the production direction 22 as indicated on the diagram. Apparatus 10 further includes a Gravure applicator roll 24 as well as a backing roll 28. There is further provided a doctor 26 in proximity to roll 24. Smoothing bars 30, 32 are disposed in contact with web 20 on the side opposite guide rolls 16 through 18. There is further provided in apparatus 10 a reservoir of coating material 34 which is used to coat paperboard 20.

In operation, paperboard 20 moves along direction 22 in contact with the nip formed by Gravure roll 24 and backing roll 28. Gravure roll 24, which may be etched or engraved with a pattern as is known in the art, is disposed in a coating solution in reservoir 34 wherein it rotates along the direction of travel of the web. Doctor 26 is used to meter the amount of coating solution that is picked up by Gravure roll 24 and applied to the underside of web 20. After the aqueous coating is applied to the web, the web is conveyed in the direction shown to smoothing bars 30 and 32 which are configured to contact the aqueous coating on the web which should be maintained in the wet state such that it may be evenly distributed by the smoothing bars. Preferably, bars 30,32 are adjustable along directions 31,33 shown in the diagrams, by being mounted for example on air cylinders (not shown). The smoothing bars are in contact with the web so as to promote the even distribution of the coating on the web; in this respect, the bars are adjustably positioned such that the amount of pressure on the paperboard may be increased or decreased as desired. During start-up of the production line bars 30-32 are advanced to contact the web prior to application of coating. The web is thus run “dry” for a short period. Likewise, the apparatus is run “dry” prior to shut down to clean the rollers before they are backed away from the web. Preferably, the rollers are driven opposite direction 22 of the web as indicated by arrows 60,70 during operation of the apparatus. Any suitable drive mechanism generally indicated at 65 may be employed.

FIG. 2 shows a rod coating apparatus 40 wherein like parts are numbered as in FIG. 1. Apparatus 40 includes generally a coating reservoir 34 provided with aqueous coating material preferably in emulsion form as well as an applicator roll 42 for applying an excess of coating 44 to the underside of the web. As the web moves in production direction 22 the coated web comes in contact with wound coil rods 46 and 48 (i.e., coil bars as disclosed in the '635 patent noted above) which meter the amount of coating applied to the paperboard substrate. As the web travels around guide rolls 12, 14, 16 and so forth, the coated web, that is the wet side of the coated web, comes in contact with smoothing bars 30 and 32 as indicated in FIGS. 1 and 2. After the coating applied by way of apparatus 40 is smoothed by bars 30, 32 the web is conveyed to a dryer wherein the board is finished and prepared for subsequent use. A pressure or tensioning guide roll 13 is suitably provided to urge the web into contact with applicator roll 42 and rods 46 and 48. Roll 13 is pivotally or otherwise adjustably mounted so that the application of coating to the web may be controlled during start up and shut down; that is to say, when roll 13 does not contact the web and urge it into contact with the applicator the web will not contact roll 42 and no coating will be applied. Further coatings may be added if so desired, for example an optional topcoat, such as an acrylic topcoat, may be included further down the production line.

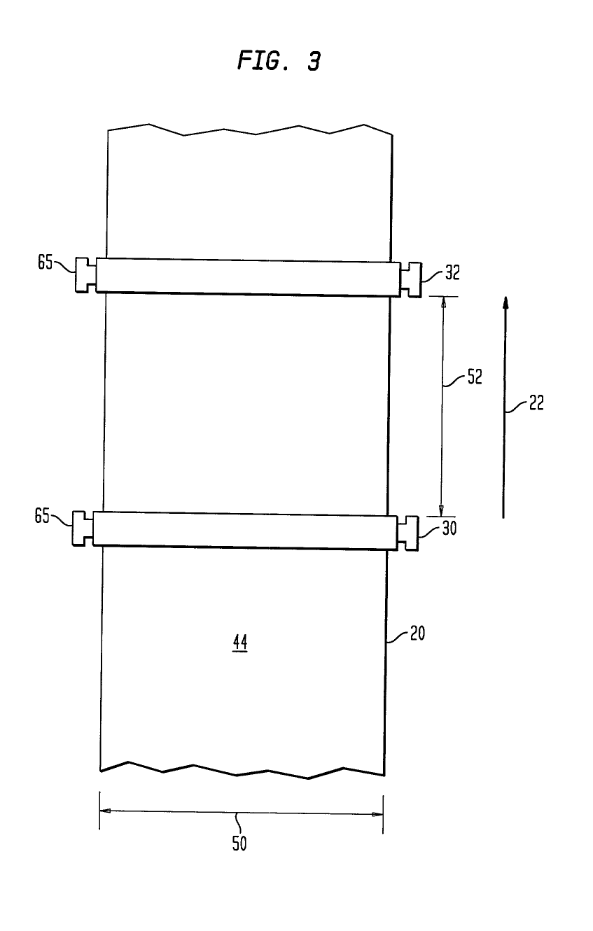

FIG. 3 is a schematic diagram of the smoothing bars shown in FIGS. 1 or 2. As noted, bars 30, 32 may be rotatably mounted about their cylindrical axis if so desired. Most preferably the smoothing bars are provided with a smooth surface so as to evenly distribute coating 44 about web 20 as it travels in production direction 22. As it may be seen from the diagram, the smoothing rolls extend across the entire width 50 of web 20 and are proximately located over a distance 52 which is typically between about 0.5 and about 5 feet.

Using the general procedures set forth above a series of paperboard was coated using the apparatii of FIGS. 1 and 2 and the product was characterized as indicated below. Results appear in Tables 1 and 2.

### Test Methods

Unless otherwise expressly indicated Parker Print Surface Roughness, Cyan Density, Dye Stain Failure and like terminology used herein has the following meanings and were measured in accordance with the procedures set forth immediately below.

The Parker Roughness method LS 1000 (microns) was used to determine roughness using the Messmer Parker Print-Surf Roughness. Operation procedure details are referenced in the Messmer Instruments Ltd. User manual for the instrument (Model No. ME-90) which is distributed by Huygen Corporation. This procedure is also generally set forth in International Standard ISO 8791 / 1-4 (1986-1992). The flat specimen is clamped under 1 Mpa pressure against a narrow annular surface by a soft backing and the resistance of air flow of the gap between the specimen and the annulus is measured. The air flow is proportional to the cube of the gap width and the roughness is expressed as the root mean cube gap in units of micrometers. Higher Parker roughness values indicate higher degrees of surface roughness.

Gravure print samples were made using a 175 lpi (lines per inch) engraving and a Flint cyan ink VMT-88343. Cyan Density was measured using an X-Rite 938 spectrodensitometer in density mode Status T with a 20 mm aperture.

Coated paperboard was tested for Dye Stain Failure, expressed as a percentage of the area of a 5 inch by 5 inch sample as follows. 15 grams of Malachite green dye (Fisher Scientific, New Jersey), 45 ml of GAP Igepal® CA-520 surfactant and 15 ml of GAP Igepap® CA-630 surfactant (Igepal® and Igegap® products are available from GAF Chemical Corp., New Jersey) are dissolved in 2940 ml of water in a large mixing vessel. The dye solution was transferred to a covered container and applied to the samples of material at a thickness of approximately 3 mm and maintained thereon for a period of 60 seconds. After having the dye removed, the samples were examined visually and the percentage of the total area of the board sample where the dye penetrated the coating and stained the board was evaluated visually and expressed as Dye Stain Failure %.

### EXAMPLES 1-11

In Examples 1-11, Tykote® Base 96038-00 (referred to herein as “Tykote”, an aqueous carboxylated styrene-butadiene emulsion (Reichold, Inc., North Carolina) was coated onto starch-sized paperboard in a single base coat in the amount shown in Table 1. Control Example 1 used sized, but uncoated, board. Weights are given in Table 1 on a dry coatweight basis, and were applied either with a Gravure (FIG. 1) or rod coating (FIG. 2) apparatus. The rod coating procedure using Mayer rods (Mayer #'s also appearing in Table 1) generally gave the best results. As may be seen from Table 1, the coated board using 2 smoothing bars was substantially smoother (lower Parker Print Surface Roughness) than either the uncoated board or that board using fewer smoothing bars. Likewise, Dye Stain Failure percentages with 2 smoothing bars were lower.

TABLE 1
Examples 1-11

| | Application | Tykote | Smoothing | Parker | Dye Stain |
|---|---|---|---|---|---|
| Variable | Type | Coatweight | Bars | Print | Failure % |
| 1 | None | 0 | 0 | 4.80 | 100 |
| (control) | | | | | |
| 2 | Gravure | 1.8 | 0 | 5.08 | 100 |
| 3 | Gravure | 1.8 | 1 | 3.75 | 70 |
| 4 | Gravure | 1.8 | 2 | 3.57 | 50 |
| 5 | Gravure | 2.1 | 0 | 5.15 | 100 |
| 6 | Gravure | 2.1 | 1 | 3.73 | 40 |
| 7 | Gravure | 2.1 | 2 | 3.33 | 20 |
| 8 | Gravure | 2.5 | 2 | 3.17 | 5 |
| 9 | Rod #3 | 1.9 | 2 | 3.47 | 10 |
| 10 | Rod #20, | 2.2 | 2 | 3.25 | 5 |
| | #10 | | | | |
| 11 | Rod #30, | 3.2 | 2 | 2.77 | 0 |
| | #15 | | | | |

### EXAMPLES 12-17

Following generally the procedure of Examples 1-11, starch sized paperboard (control Examples 12, 13) is compared with Gravure-coated (2 smoothing bars, single Tykote coating) as well as clay coated board. Here again, the coated paperboard is much smoother than the uncoated board, even when no filler is used. Likewise, the barrier properties as exhibited by Cyan Density are enhanced, and approach the properties of clay-coated board. Control Example 17 was prepared in accordance with U.S. Pat. No. 5,776,619 to Shanton including a clay pigment layer and an acrylic topcoat.

TABLE 2
Examples 12-17

| | | | | | Cyan |
|---|---|---|---|---|---|
| | Application | Tykote | Smoothing | Parker | Density |
| Variable | Type | Weight | Bars | Print | 20 mm |
| 12 (control) | None | 0 | 0 | 8.00 | <1.00 |
| 13 (control) | None | 0 | 0 | 4.80 | <1.00 |
| 14 | Gravure | 1.8 | 2 | 3.57 | 1.24 |
| 15 | Gravure | 2.1 | 2 | 3.33 | 1.36 |
| 16 | Gravure | 2.5 | 2 | 3.17 | 1.39 |
| 17 (control) | Clay coating | 0 | 0 | 1.9 | 1.56 |

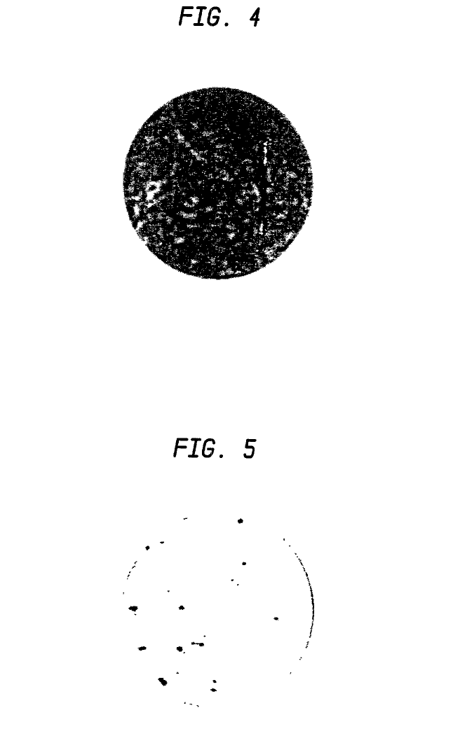

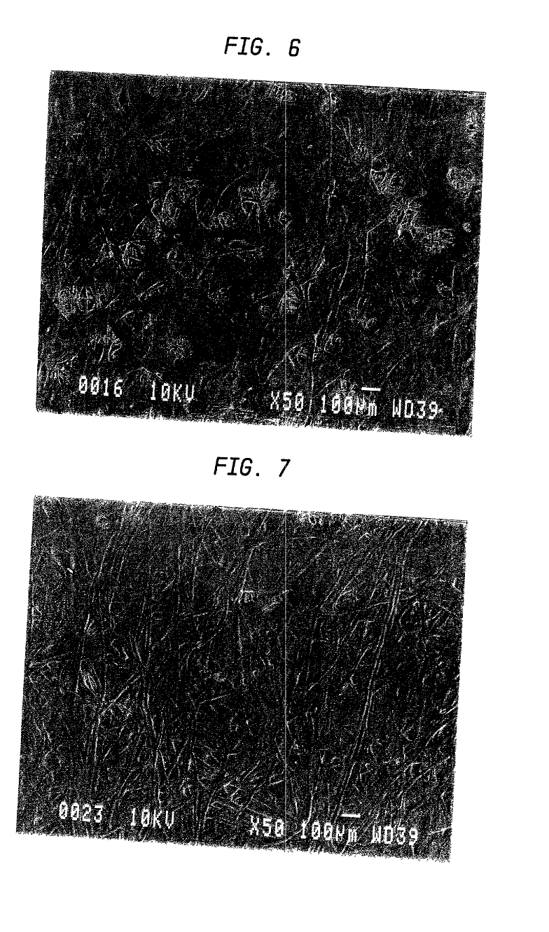

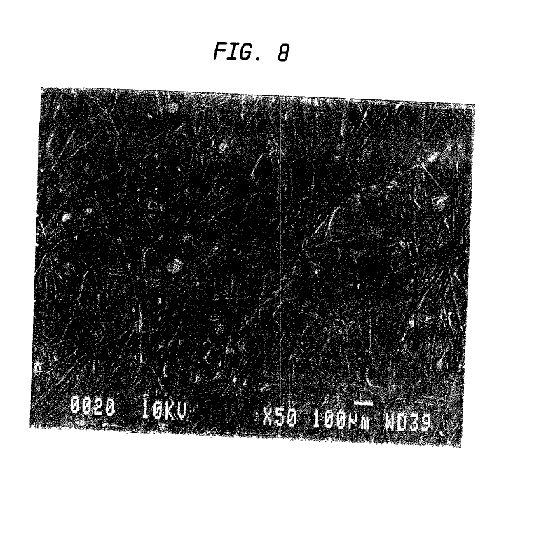

The present invention is further appreciated by reference to FIGS. 4 through 8. FIG. 4 is a black and white representation of a portion of paperboard from Example 5 which exhibited a Dye Stain Failure of about 100%. FIG. 5 is a black and white representation of a pattern of dye-treated paperboard which was prepared as in Example 7 (which is identical to Example 5, except that dual smoothing bars are used) which exhibited a Dye Stain Failure of about 20%. As can be seen from the diagrams, the enhancements in barrier properties are dramatic, even when low coatweights are employed. Likewise, it may be seen from FIGS. 6, 7 and 8 that the coatings applied in accordance with the present invention exhibit fewer large pinholes. FIG. 6 is a photomicrograph (50×) of a sample of paperboard from example 5 (no smoothing bars); FIG. 7 is a photomicrograph (50×) of a sample of paperboard from Example 6 (1 smoothing bar); whereas FIG. 8 is a photomicrograph of a sample from Example 7 of the invention which shows a substantial absence of large pinholes which reduce barrier properties. Pinholes with a diameter (or largest dimension in the case of non-circular voids) of about 50 microns or greater are particularly detrimental to the barrier performance of the coating. Such pinholes are deemed “substantially absent” if, on average, the paperboard has less than about 2 such voids on a 5 inch by 5 inch square sample.

The apparatus and method of the present invention is typically practiced in connection with a paperboard substrate having a basis weight of generally from about 75 to about 300 pounds per 3000 square foot ream wherein the smoothing bars are substantially perpendicular to the production direction of the paperboard. In general, the dual smoothing bars are spaced apart a distance of from about 0.5 to about 5 feet but more typically spaced apart a distance of from about 1 to about 3 feet. The applicator used to supply coating to the paperboard may be a Gravure apparatus as shown in FIG. 1 or a rod coating apparatus as was described in connection with FIG. 2 and is described in U.S. Pat. No. 4,521,459 to Takeda et al. noted above. Typically, Gravure applicator rolls are engraved so as to carry coating material to the substrate and the amount of material is metered by a doctor blade as is known in the art. In a typical Gravure type apparatus a backing roll such as a rubber backing roll may be opposing the Gravure roll as shown in FIG. 1 during the process. The coated paperboard substrate produced in accordance with the present invention typically exhibits a Parker Print Surface Roughness of less than about 3.75 microns and typically less than about 3.5 microns. The Parker Print Surface Roughness of less than about 3 microns is preferred. Prior to coating the substrate with an aqueous polymeric coating it is typical that the paperboard be sized in a starch press prior to application of the base coat. Suitable commercially available sizing agents containing starch include: “PENFORD.RTM. GUMS 200,” “PENFORD.RTM. GUMS 220,” “PENFORD.RTM. GUMS 230,” “PENFORD.RTM. GUMS 240,” “PENFORD.RTM. GUMS 250,” “PENFORD.RTM. GUMS 260,” “PENFORD.RTM. GUMS 270,” “PENFORD.RTM. GUMS 280,” “PENFORD.RTM. GUMS 290,” “PENFORD.RTM. GUMS 295,” “PENFORD.RTM. GUMS 300,” “PENFORD.RTM. GUMS 330,” “PENFORD.RTM. GUMS 360,” “PENFORD.RTM. GUMS 380,” “PENFORD.RTM. GUMS PENCOTE.RTM.,” “PENFORD.RTM. GUMS PENSPRAE.RTM. 3800,” “PENFORD.RTM. GUMS PENSURF,” “PENGLOSS.RTM.,” “APOLLO.RTM. 500,” “APOLLO.RTM. 600,” “APOLLO.RTM. 600-A,” “APOLLO.RTM. 700,” “APOLLO.RTM. 4250,” “APOLLO.RTM. 4260,” “APOLLO.RTM. 4280,” “ASTRO.RTM. GUMS 3010,” “ASTRO.RTM. GUMS 3020,” “ASTROCOTE.RTM. 75,” “POLARIS.RTM. GUMS HV,” “POLARIS.RTM. GUMS MV,” “POLARIS.RTM. GUMS LV,” “ASTRO.RTM. X 50,” “ASTRO.RTM. X 100,” ASTRO.RTM. X 101,“ASTRO.RTM. X 200,” “ASTRO.RTM. GUM 21,” “CALENDER SIZE 2283,” “DOUGLAS.RTM.-COOKER 3006,” “DOUGLAS.RTM.-COOKER 3007,” “DOUGLAS.RTM.-COOKER 3012-T,” “DOUGLAS.RTM.-COOKER 3018,” “DOUGLAS.RTM.-COOKER 3019,” “DOUGLAS.RTM.-COOKER 3040,” “CLEARSOL.RTM. GUMS 7,” “CLEARSOLS.RTM. GUMS 8,” “CLEARSOL.RTM. GUMS 9,” “CLEARSOL.RTM. GUMS 10,” “DOUGLASO.RTM.-ENZYME 3622,” “DOUGLAS.RTM.-ENZYME E-3 610,” “DOUGLAS.RTM.-ENZYME E-3615,” “DOUGLAS.RTM.-ENZYME 3022,” “DOUGLAS.RTM.-ENZYME 3023,” “DOUGLAS.RTM.-ENZYME 3024,” “DOUGLAS.RTM.-ENZYME E,” “DOUGLAS.RTM.-ENZYME EC,” “CROWN THIN BOILING X-10,” “CROWN THIN BOILING X-18,” “CROWN THIN BOILING XD,” “CROWN THIN BOILING XF,” “CROWN THIN BOILING XH,” “CROWN THIN BOILING XJ,” “CROWN THIN BOILING XL,” “CROWN THIN BOILING XN,” “CROWN THIN BOILING XP,” “CROWN THIN BOILING XR,” “DOUGLAS.RTM.-UNMODIFIED PEARL,” and “DOUGLAS.RTM.-UNMODIFIED 1200.” These sizing agents are all commercially available from Penford Products Co. “PENFORD.RTM.,” “PENCOTE.RTM.,” “PENSPRAE.RTM.,” “PENGLOSS.RTM.,” “APOLLO.RTM.,” “ASTRO.RTM.,” “ASTROCOTE.RTM.,” “POLARIS.RTM.,” “DOUGLAS.RTM.,” and “CLEARSOL.RTM.” are all registered trademarks of Penford Products Co. Other suitable starches, including “SILVER MEDAL PEARL.TM.,” “PEARL B,” “ENZO 32 D,” “ENZO 36W,” “ENZO 37D,” “SIJPERFILM 230D,” “SUPERFILM 235D,” “SUPERFILM 240DW,” “SUPERFILM 245D,” “SUPERFILM 270W,” “SUPERFILM 280DW,” “PERFORMER 1,” “PERFORMER 2,” “PERFORMER 3,” “CALIBER 100,” “CALIBER 110,” “CALIBER 124,” “CALIBER 130,” “CALIBER 140,” “CALIBER 150,” “CALIBER 160,” “CALIBER 170,” “CHARGE +2,” “CHARGE +4,” “CHARGE +7,” “CHARGE +9,” “CHARGE +88,” “CHARGE +99,” “CHARGE +110,” “FILMFLEX 40,” “F1LMFLEX 50,” “FILMFLEX 60,” and “FILMFLEX 70,” are all commercially available from Cargill, Inc. Cofilm compositions which are film forming starch compositions available from National Starch are also preferred in some cases.

Typically, the paperboard is sized with starch in an amount of from about 5 to 15 pounds per 3000 square foot ream with from about 5 to about 8 or about 6 to 7 pounds per 3000 square foot ream being typical in some embodiments. The polymer coating may include a mineral filler and a polymer binder resin therewith in which case a typical mineral filler is kaolin. In other, perhaps still more preferred embodiments, an aqueous dispersion is substantially mineral free and consists essentially of a styrene-butadiene resin. A styrene-butadiene resin provides reasonably good print quality when coated in accordance with the invention in an amount of at least about 2 pounds per 3000 square foot ream. From about 2 to less than about about 5 pounds per 3000 square foot ream may be employed. At least about 2.5 pounds per 3000 square foot ream is preferred as is a substantially pin-hole free coated substrate. Less than 4 pounds of base coating per 3000 square foot ream is typically all that is required. Paperboard coated with one or more base coats applied in accordance with the present invention may further include a topcoat applied to the base coat. Typically the topcoat must enhance the barrier properties of the paperboard as well as preferably having suitable release properties from a heated die set. In this respect acrylic coatings are particularly preferred. Suitable acrylic coatings may include multiple coatings consisting essentially of an acrylic resin composition. By acrylic coating it is meant that any suitable acrylic emulsion may be used. Such emulsions are generally polymers of acrylic acid or its derivatives and salts. Such compounds may include one or more of the following: polyacrylics and polyacrylic acids such as poly(benzyl acrylate), poly(butyl acrylate)(s), poly(2-cyanobutyl acrylate), poly(2-ethoxyethyl acrylate), poly(ethyl acrylate), poly(2-ethylhexyl acrylate), poly(fluoromethyl acrylate), poly(5,5,6,6,7,7,7 heptafluoro-3-oxaheptyl acrylate), poly(heptafluoro-2-propyl acrylate), poly(heptyl acrylate), poly(hexyl acrylate), poly(isobornyl acrylate), poly(isopropyl acrylate), poly(3-methoxybutyl acrylate), poly(methyl acrylate), poly(nonyl acrylate), poly(octyl acrylate), poly(propyl acrylate), poly(p-tolyl acrylate), poly(acrylic acid) and derivatives and salts thereof; polyacrylamides such as poly(acrylamide), poly(N-butylacrylamide), poly(N, N-dibutylacrylamide), poly(N-dodecylacrylamide), and poly(morpholylacrylamide); polymethacrylic acids and poly(methacrylic acid esters) such as poly(benzyl methacrylate), poly(octyl methacrylate), poly(butyl methacrylate), poly(2-chloroethyl methacrylate), poly(2-cyanoethyl methacrylate), poly(dodecyl methacrylate), poly(2-ethylhexyl methacrylate), poly(ethyl methacrylate), poly(1,1,1-trifluoro-2-propyl methacrylate), poly(hexyl methacrylate), poly(2-hydroxyethyl methacrylate), poly(2-hydroxypropyl methacrylate), poly(isopropyl methacrylate), poly(methacrylic acid), poly(methyl methacrylate) in various forms such as, atactic, isotactic, syndiotactic, and heterotactic; and poly(propyl methacrylate); polymethacrylamides such as poly(4-carboxyphenylmethacrylamide); other alpha- and beta-substituted poly(acrylics) and poly(methacrylics) such as poly(butyl chloracrylate), poly(ethyl ethoxycarbonylmethacrylate), poly(methyl fluoroacrylate), and poly(methyl phenylacrylate). The finish coating layer or layers should be FDA approved material.

Paperboard produced in accordance with the present invention is particularly suitable for making paperboard blanks which may be formed into a paperboard food container by heat pressing as would be appreciated by one of skill in the art. Illustrative in this regard are U.S. Pat. Nos. 4,606,496 entitled “Rigid Paperboard Container” of R. P. Marx et al; U.S. Pat. No. 4,609,140 entitled “Rigid Paperboard Container and Method and Apparatus for Producing Same” of G. J. Van Handel et al; U.S. Pat. No. 4,721,499 entitled “Method of Producing a Rigid Paperboard Container” of R. P. Marx et al; U.S. Pat. No. 4,721,500 entitled “Method of Forming a Rigid Paper-Board Container” of G. J Van Handel et al; U.S. Pat. No. 5,088,640 entitled “Rigid Four Radii Rim Paper Plate” of M B. Littlejohn; U.S. Pat. No. 5,203,491 entitled “Bake-In Press-Formed Container” of R. P. Marx et al; and U.S. Pat. No. 5,326,020 entitled “Rigid Paperboard Container” of J O. Chesire et al. Equipment and methods for making paperboard container are also disclosed in U.S. Pat. Nos. 4,781,566 entitled “Apparatus and Related Method for Aligning Irregular Blanks Relative to a Die Half” of A. F. Rossi et al; U.S. Pat. No. 4,832,677 entitled “Method and Apparatus for Forming Paperboard Containers” of A. D. Johns et al; and U.S. Pat. No. 5,249,946 entitled “Plate Forming Die Set” of R. P. Marx et al.

A preferred apparatus and method of practicing the present invention includes driving the rolls in a direction opposite to the direction of travel of the web. Dye Stain Failures of less than 10% are readily achieved, whereas Dye Stain Failures of less than 5% are preferred.

While the invention has been illustrated and described in connection with numerous aspects thereof, modifications to specific embodiments within the spirit and scope of the present invention, set forth in the appended claims, will be readily apparent to one of skill in the art.

What is claimed is:

1. An apparatus for applying an aqueous polymeric coating to a paperboard substrate comprising:
(a) means for conveying a paperboard substrate having a basis weight of from about 75 pounds per 3000 square foot ream to about 300 pounds per 3000 square foot ream in a production direction;
(b) applicator means for applying a metered amount of said aqueous polymeric coating to said paperboard substrate as it travels along said production direction;
(c) means for smoothing said aqueous polymeric coating on said paperboard substrate as it travels along said production direction comprising:
(i) a first smoothing bar extending transversely to said production direction configured, dimensioned and positioned to contact said aqueous polymeric coating and promote uniform distribution thereof over the surface of said paperboard substrate; and
(ii) a second smoothing bar proximately located with respect to said first smoothing bar likewise extending transversely to said production direction configured, dimensioned and positioned to contact said aqueous coating and promote uniform distribution thereof over the surface of said paperboard substrate.

2. The apparatus according to claim 1, wherein said first and second smoothing bars are substantially perpendicular to said production direction.

3. The apparatus according to claim 2, wherein said first and second smoothing bars are spaced apart a distance of from about 0.5 ft. to about 5 ft.

4. The apparatus according to claim 3, wherein said first and second smoothing bars are spaced apart a distance of from about 1 ft. to about 3 ft.

5. The apparatus according to claim 1, wherein said applicator means comprises a Gravure roll.

6. The apparatus according to claim 5, wherein said Gravure roll has an engraved applicator surface.

7. The apparatus according to claim 5, further comprising a doctor blade positioned to meter the amount of aqueous polymeric coating on said Gravure roll.

8. The apparatus according to claim 5, further comprising a backing roll opposing said Gravure roll.

9. The apparatus according to claim 1, wherein said applicator means includes a rod applicator for metering the amount of aqueous polymeric coating applied to said paperboard substrate.

10. The apparatus according to claim 1, wherein said first and second smoothing bars are rotatably mounted and further comprising means for driving said first and second smoothing bars in a direction of rotation opposite said production direction.

11. A method of coating a paperboard substrate comprising:
(a) conveying a paperboard substrate having a basis weight of from about 75 pounds per 3000 square foot ream to about 300 pounds per 3000 square foot ream in a production direction;
(b) applying a metered amount of an aqueous polymeric coating to said paperboard substrate as it travels along said production direction;
(c) smoothing said aqueous coating on said paperboard substrate by way of:
(i) contacting said aqueous polymeric coating with a first smoothing bar as the coated substrate travels in said production direction, said first smoothing bar extending transversely to said production direction and being operative to promote uniform distribution of said aqueous polymeric coating over the surface of said paperboard substrate; and
(ii) contacting said aqueous polymeric coating with at least a second smoothing bar proximately located to said first smoothing bar as the coated substrate travels in said production direction, said second smoothing bar likewise extending transversely to said production direction and being operative to promote uniform distribution of said aqueous polymeric coating over the surface of said paperboard substrate; and
(d) drying said aqueous coating to form a polymer coated paperboard substrate.

12. The method according to claim 11, wherein said coated paperboard substrate has a Parker Print surface roughness of less than about 3.75.

13. The method according to claim 12, wherein said coated paperboard substrate has a Parker Print surface roughness of less than about 3.5.

14. The method according to claim 13, wherein said coated paperboard substrate has a Parker Print surface roughness of less than about 3.

15. The method according to claim 12, wherein said paperboard substrate is sized with starch in an amount of from about 5 pounds per 3000 square foot ream to about 15 pounds per 3000 square foot ream prior to being coated with said aqueous polymeric coating.

16. The method according to claim 11, wherein said aqueous coating comprises a mineral filler and a binder resin.

17. The method according to claim 16, wherein said mineral filler is kaolin.

18. The method according to claim 11, wherein said aqueous coating consists essentially of an aqueous dispersion of a styrene-butadiene resin.

19. The method according to claim 18, wherein said coated paperboard substrate has a styrene-butadiene coatweight of less than about 3 pounds per 3000 square foot ream.

20. The method according to claim 19, wherein said coated paperboard has a styrene-butadiene coatweight of at least about 2 pounds per 3000 square foot ream.

21. The method according to claim 20, wherein said coated paperboard exhibits a Dye Stain Failure of less than about 10%.

22. The method according to claim 21, wherein said coated paperboard exhibits a Dye Stain Failure of less than about 5%.

23. The method according to claim 11, wherein said coated paperboard exhibits a Dye Stain Failure of less than about 10%.

24. The method according to claim 23, wherein said coated paperboard exhibits a Dye Stain Failure of less than about 5%.

25. The method according to claim 11, wherein said coated paperboard is characterized by a substantial absence of pinholes having a dimension of 50 microns or greater.

26. A coated paperboard having a basis weight of from about 75 pounds per 3000 square foot ream to about 300 pounds per 3000 square foot ream consisting essentially of a starch-sized cellulosic web provided with a base coating, said base coating being applied to said paperboard substrate by applicator means and smoothed by a first smoothing bar and a second smoothing bar proximate to said first smoothing bar, said coated paperboard exhibiting a Dye Stain Failure of less than about 10%.

27. The coated paperboard according to claim 26, wherein said coated paperboard has a Parker Print Surface Roughness of less than about 3.5.

28. The coated paperboard according to claim 27, wherein said coated paperboard has a Parker Print Surface Roughness of less than about 3.

29. The coated paperboard according to claim 26, wherein said cellulosic web is sized with starch in an amount of from about 5 pounds per 3000 square foot ream to about 8 pounds per 3000 square foot ream.

30. The coated paperboard according to claim 29, wherein said cellulosic web is sized with starch in an amount of from about 6 pounds per 3000 square foot ream to about 7 pounds per 3000 square foot ream.

31. The coated paperboard according to claim 26, wherein said coated paperboard has a basis weight of from about 100 pounds per 3000 square foot ream to about 175 pounds per 3000 square foot ream.

32. The coated paperboard according to claim 26, wherein said coated paperboard further comprises an acrylic topcoat applied to said base coat.

33. The coated paperboard according to claim 26, wherein said base coating is applied to said paperboard in an amount of from about 2 pounds per 3000 square foot ream to less than 4 pounds per 3000 square foot ream and wherein said base coating is characterized by a substantial absence of pinholes having a dimension of 50 microns or greater.

34. The coated paperboard according to claim 33, wherein said base coating is applied to said paperboard in an amount of less than about 3 pounds per 3000 square foot ream.

35. The coated paperboard according to claim 27, wherein said coated paperboard exhibits a Dye Stain Failure of less than about 5%.

36. The coated paperboard according to claim 35, wherein said base coat comprises a mineral filler and a binder resin.

37. The coated paperboard according to claim 26, wherein said base coat consists essentially of a styrene-butadiene resin applied in an amount of from about 2 to less than 4 pounds per 3000 foot ream.

38. An unfilled coated paperboard having a basis weight of from about 75 pounds per 3000 square foot ream to about 300 pounds per 3000 square foot ream consisting essentially of a starch-sized cellulosic web provided with a base coating consisting essentially of a resin coating in a coatweight amount of less than about 5 pounds per 3000 square foot ream, said coated paperboard exhibiting a Dye Stain Failure of less than about 10%.

39. The unfilled coated paperboard according to claim 38, wherein said coated paperboard has a Parker Print Surface Roughness of less than about 3.5.

40. The unfilled coated paperboard according to claim 39, wherein said coated paperboard has a Parker Print Surface Roughness of less than about 3.

41. The unfilled coated paperboard according to claim 38, wherein said base coating consists essentially of a styrene-butadiene resin coating.

42. The unfilled coated paperboard according to claim 41, wherein said styrene-butadiene coating is applied in a coatweight amount of from about 2 pounds per 3000 square foot ream to less than about 5 pounds per 3000 square foot ream.

43. The unfilled coated paperboard according to claim 42, wherein said styrene-butadiene resin coating is applied to said paperboard in an amount of less than about 3 pounds per 3000 square foot ream.

44. The unfilled coated paperboard according to claim 38, further comprising a topcoat.

45. The unfilled coated paperboard according to claim 44, wherein said topcoat comprises an acrylic resin.

46. The unfilled coated paperboard according to claim 41, further comprising a topcoat.

47. The unfilled coated paperboard according to claim 46, wherein said topcoat comprises an acrylic resin.

48. The unfilled coated paperboard according to claim 38, wherein said paperboard exhibits a Dye Stain Failure of less than about 5%.

49. The unfilled coated paperboard according to claim 38, wherein said base coating is substantially free of pinholes having a dimension of about 50 microns or greater, and said base coating is applied to said paperboard in an amount of less than about 4 pounds per 3000 square foot ream.

50. The unfilled coated paperboard according to claim 49, wherein said base coating is applied in a coatweight amount of less than about 3 pounds per 3000 square foot ream.

51. A coated paperboard container prepared by heat pressing a paperboard blank prepared from the unfilled coated paperboard according to claim 38.

52. A coated paperboard having a basis weight of from about 75 pounds per 3000 square foot ream to about 300 pounds per 3000 square foot ream consisting essentially of a starch-sized cellulosic web provided with a base coating in an amount of from about 2 pounds per 3000 square foot ream to less than 4 pounds per 3000 square foot ream, said base coating being substantially free of pinholes having a dimension of 50 microns or greater.

53. The coated paperboard according to claim 52, wherein said base coating is provided in an amount of less than about 3 pounds per 3000 square foot ream.

54. The coated paperboard according to claim 52, wherein said base coating consists essentially of a styrene-butadiene resin.

55. The coated paperboard according to claim 54, wherein said coated paperboard further comprises an acrylic topcoat.
